(19) United States
(12) Patent Application Publication
(10) Pub. No.: US 2008/0266836 A1
(43) Pub. Date: Oct. 30, 2008

(54) Articulated aquarium light

(76) Inventor: Marcus Hadley, Orlando, FL (US)

Correspondence Address: Taylor Ross, 13521 Eyas Road, Orlando, FL, 32837, US

(21) Appl. No.: 11/796,507

(22) Filed: Apr. 27, 2007

(51) Int. Cl. F21V 33/00

(52) U.S. Cl. 362/101

(57) ABSTRACT

An articulated aquarium light is combined with a display case. The light is secured to ground, includes an upright support, and a cantilevered arm mounting one or more operative units, such as lights, etc. The light may include adjustment for the length of the support, thus allowing the cantilevered arm to be moved upward or downward. The light may alternatively or additionally include adjustment of the angular position of the cantilevered arm, thus allowing the arm to swing away from the case.

### CROSS-REFERENCE TO RELATED APPLICATIONS

Not Applicable

### BACKGROUND OF THE INVENTION

The present invention relates in general to lighting systems for aquariums, terrariums and the like. In particular, it relates to such a lighting system which is articulated to permit adjustment to vary light intensity and/or to permit access to the aquarium.

### DESCRIPTION OF THE RELATED ART

Open-topped glass cases are well known for use as aquariums and terrariums. It is also known to provide lights for aquariums and terrariums for a variety of reasons: viewing light; living requirements for the flora and/or fauna encased; heat; etc. Despite the widespread use of aquariums and terrariums the choices for lighting systems are quite small.

At the low end of the price spectrum there are various lights which attach to the rim of so-called “micro-aquariums” (those of one gallon (3.8 liter) capacity or less). The small, lightweight nature of these lights has permitted some adjustment features. For example, vertical adjustment or limited upward pivot are both known. The attachment to the rim employed in these lights will not, however, permit similar arrangements with large heavy hoods typically found on cases of 10 gallon (38 liter) capacity or higher (hereafter a “large case”).

For these large cases (especially those over 100 gallon (380 liter) (hereafter “very large case”)), and at the mid-range of the market, it is common to provide a hood which completely encloses the open top of the case. One or more lights are mounted on the interior of the hood. The hood often includes a hinged section to provide partial access to the interior of the case without the need to remove the hood. This hinged section is important, because the hood and associated light are typically heavy and cumbersome to remove. Unfortunately, for certain types of uses —such as saltwater reef displays—complete removal of the hood is required much more frequently.

For the most high-end units—and typically associated with saltwater reef systems—it has been known to suspend the hood by wires a small distance above the case. This arrangement provides a certain amount of access to the case. However, it is primarily an aesthetic-driven arrangement rather than having any utilitarian purpose.

### SUMMARY OF THE INVENTION

An object of the present invention is to provide a light system for aquariums and terrariums which is articulated to permit adjustment.

Another object of the present invention is to provide such a system in which the articulation includes vertical movement to allow variation in light intensity.

A further object of the present invention is to provide such a system in which the articulation includes oscillation to swing the lights away from the case to permit full access to the case.

Yet another object of the invention of to provide such articulation which is power driven, including with timer or other logic control.

These and other objects are achieved by an articulated aquarium light combined with a display case. The light comprises means for securing the light to ground, an upright support, and a cantilevered arm mounting one or more operative units, such as lights, etc. The light may include means for adjusting the length of the support, thus allowing the cantilevered arm to be moved upward or downward. The light may alternatively or additionally include means for adjusting the angular position of the cantilevered arm, thus allowing the arm to swing away from the case.

### BRIEF DESCRIPTION OF THE DRAWINGS

The objects and features of the invention noted above are explained in more detail with reference to the drawings, in which like reference numerals denote like elements, and in which:

FIG. 1 is a perspective view of a case with light system;

FIG. 2 is a detail perspective view showing a second embodiment of the invention;

FIG. 3 is a detail perspective view showing a third embodiment of the present invention;

FIG. 4 is a perspective view showing a frame according to the present invention;

FIG. 5 is a perspective view showing a further embodiment of the invention;

FIG. 6 is a detail cross-sectional view showing a further embodiment of the invention;

FIG. 7 is a plan view showing the rest and work positions of the an embodiment of the present invention;

FIG. 8 is a plan view showing the rest and work positions of a further embodiment of the invention;

FIG. 9 is a cross-sectional view of an embodiment of the present invention;

FIG. 10 is a detail view from FIG. 9;

FIG. 11 is a perspective view showing the rest and work positions of a another embodiment of the invention; and

FIG. 12 is a perspective view showing the rest and work positions of a final embodiment of the invention.

### DETAILED DESCRIPTION OF THE INVENTION

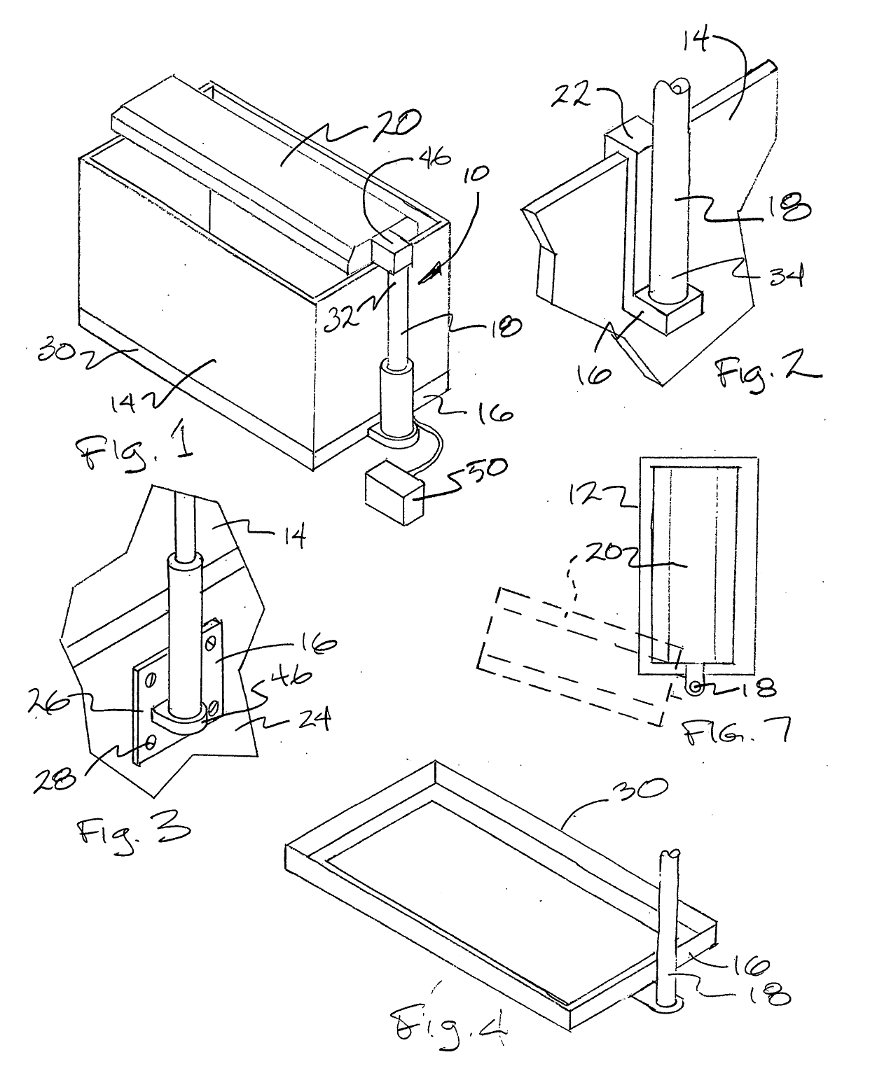

With reference to FIG. 1, an articulated aquarium light according to the present invention is generally designated by reference numeral 10. The light 10 is used in conjunction with a case 12 housing living things, and acting as an aquarium or terrarium. The case 12 will be described first.

The case 12 is of the type commonly used for aquariums or terrariums. The case 12 typically includes a base wall (not shown) and one or more side walls 14. The upper rim of these side walls define an opening providing access to the interior. In the example shown, there are 4 side walls 14, forming a generally rectangular case 12. There are, however, many available shapes for such cases 12. The base and side walls are often formed of glass, although other materials are sometimes used for the base wall or side walls which would form a rear of the case 12. For viewing purposes at least one side wall 14 is commonly transparent glass or plastic.

The light 10 used in conjunction with the case 12 generally comprises means 16 for securing the light to ground, an upright support 18, and a cantilevered arm 20. These elements are connected together serially. Specifically, support 18 is mounted to the securing means 16, and the cantilevered arm 20 is mounted to the support 18. The cantilevered arm 20 will finally mount the various lights, heaters or other equipment desired to be held over the case 12.

The means 16 for securing the light to ground may take various forms. As illustrated in FIG. 2, the means 16 may take the form of a hook bracket 22 hung upon the side wall 14. If desired, there could be a set screw (not shown) to further secure the bracket 22 to side wall 14. As may be envisioned, this bracket 22 will prevent the unintended movement of the support 18 and thus serves to secure the light 10 to ground.

A further embodiment for the means 16 is shown in FIG. 3. In this embodiment, the case 12 rests upon ground 24, which may comprise the floor, a wall, or some piece of furniture such as a dedicated stand. In this arrangement the means 16 comprises a simple plate 26 secured directly to the ground by one or more fasteners 28. Other known fasteners, such as bolts, glue, etc. could of course be used. Further, the mounting position of the plate need not be below the case 12, but could be above.

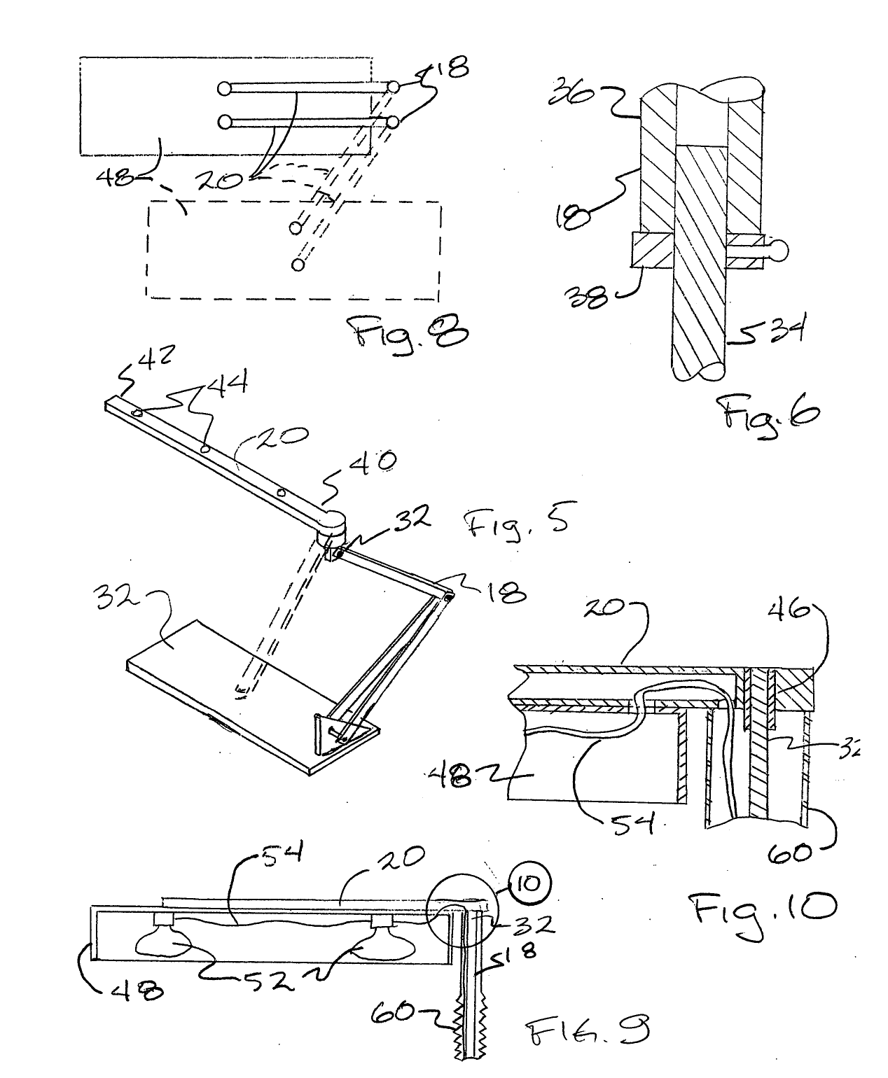

Yet another embodiment of the means 16 is illustrated by comparison of FIGS. 1 and 4. In FIG. 4 there is shown a frame 30 having a peripheral shape and size chosen to match that of the case 12. As shown in FIG. 1, the case 12 is received within and rests upon the frame 30. The weight of the case 12 itself serves to hold the means 16 in position. A similar arrangement is shown in FIG. 5 where a simple plate 32 serves to form the means 16. In a manner similar to the frame 30, the plate 32 would be wedged between the case 12 and ground. While acceptable, the plate 30 is not as preferred as the frame 30, since the frame 30 includes peripheral side walls closely receiving the case 12 to prevent lateral movement of the frame 30.

The means 16 may thus take a variety of forms, and more particularly, may work in a variety of manners. Specifically, the means 16 may secure directly to the case 12, and via the case 12 secure the light 10 to the ground. Alternatively, the means 16 may be connected directly to the ground to the secure the light 10. As another example, the means 16 may be held between the case 12 and the ground to secure the light 10 to the ground.

As noted above, the upright support 18 is mounted on the means 16, and in turn mounts the arm 20. As such, the support 18 includes a first end 34 mounted to the means 16, and a second end 36 mounted to the arm 20. The upright support 18 may be a simple rigid element, holding the arm 20 at a constant vertical distance from means 16 (and thus above the case 12). However, one of the features of the present invention is that the support 18 may permit adjustment of its length.

This vertical adjustment is desirable for several reasons. First, it can serve to lift the cantilevered arm 20 a greater distance from case 20 thus allowing improved access to the interior of case 12. It is also desirable to adjust the distance between the arm 20 and case 12 to vary the amount of light and/or heat provided to the case 12. For example, the lights commonly employed for live reef aquariums vary in intensity through their service life. To reduce extreme changes in light (which can be harmful to the costly reef flora and fauna), it would be desirable to move the arm 20 upward upon installing new bulbs, and gradually move the arm 20 downward as the bulbs age. In similar manner but on a shorter time scale, the height of arm 20 could be adjusted so as to intentionally provide limited variation in light intensity so as to more closely mimic natural conditions.

A first adjustment example is illustrated in FIG. 3, where the support 18 takes the form of a spring-biased piston and cylinder combination. The spring will be chosen or adjusted according to the weight of the arm 20 to hold it in a constant position absent moving force applied manually by the user. A second example is shown in FIG. 5 where the support 18 takes the form of a pair of articulated arms arranged similarly to that known for desk lamps. The joints may include appropriate stops to secure them in a desired angle, and/or the articulated arms may be spring biased in ways known in the arts. A further example is shown in FIG. 6, where the first end 34 comprises a rod, second end 36 comprises a sleeve, and below the sleeve there is provided a ring stop 38 having a manual set screw. Each of these arrangements are encompassed by the general term “means for manual length adjustment of the upright support”.

The previous examples of support 18 permitted manual adjustment of the vertical position of arm 20. It is of course also possible to arrange for powered movement. For example, the embodiment of FIG. 1 shows a piston and cylinder combination driven hydraulically. As can be imagined, a pneumatically powered piston and cylinder could also be used. Other possibilities include an electrically driven rack and pinion, hydraulically driven articulated arms (similar to FIG. 5), electrically driven screws operating scissors linkages, etc. Each of these arrangements are encompassed by the general term “means for powered length adjustment of the upright support”. Similarly, when combined with the means for manual length adjustment of the upright support, these arrangements together are encompassed by the general term “means for length adjustment of the upright support”.

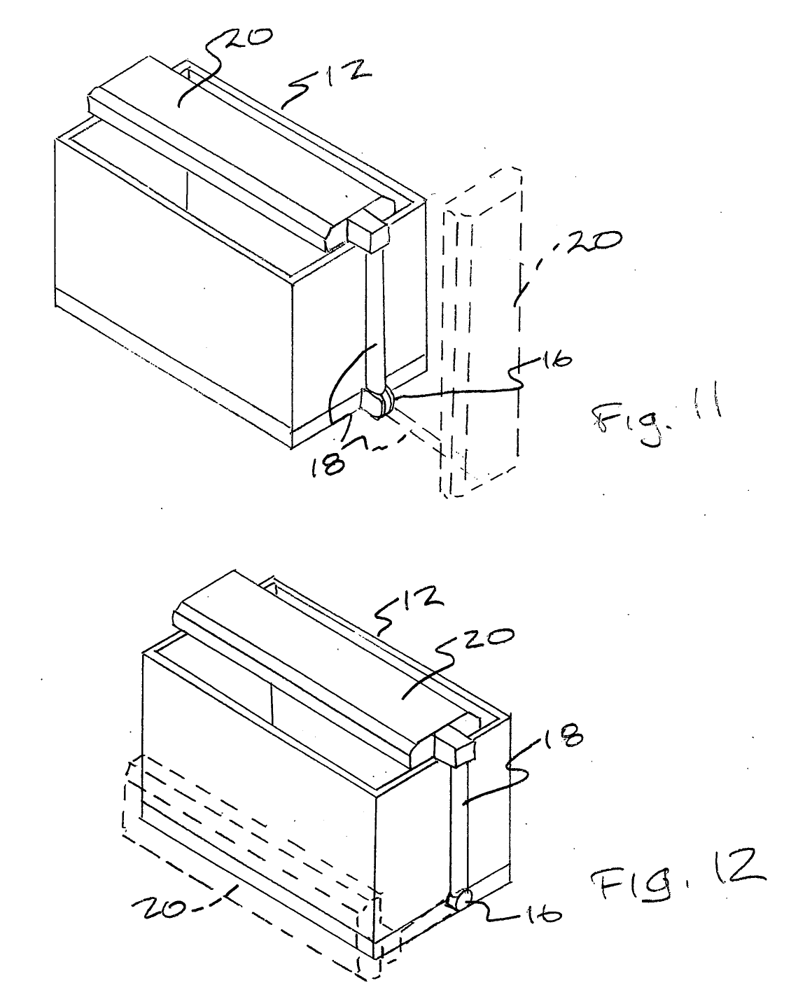

The final component of light 10 is the cantilevered arm 20. As noted above, arm 20 is mounted to the second end of support 18. Arm 20 itself includes an inner end 40 connected to the support 18, and extends outward to a free outer end 42. As shown in FIG. 1, the arm 20 may itself form a hood or similar encasing structure for the various lights, heaters or other equipment to be held over case 12. Alternatively, arm 20 may take the form of a simple rod adapted to itself mount one or more models of hoods sold separately (48 in FIG. 9). In such a situation, the arm 20 could include holes 44 for mounting bolts, or be adapted in a variety of other ways to permit mounting of the separate hood.

As with the support 18, it is possible that the arm 20 have a simple static connection to the support 18. However, one of the features of the present invention that the arm 20 permit adjustment of its angular orientation.

Simple manual angular adjustment may be achieved by providing a journal 46 at the mounting point between the arm 20 and support 18, as in FIG. 1. Alternatively, the natural play within the piston and cylinder combination (or rod and sleeve combination as in FIG. 6) used for support 18 may permit such adjustment. Another possibility is to provide the journal 46 not at the connection of support 18 and arm 20, but rather at the connection of the means 16 and support 18, as shown in FIG. 3.

The effect of the angular adjustment of arm 20 is best illustrated in FIG. 7. The rest position of the arm 20 over case 12 is shown in full line. The arm 20 may, however, be manually moved to the work position shown in phantom. In the work position the interior of case 12 is readily available to users or workers for any necessary maintenance. When finished, the arm 20 may be rotated (actually oscillated) back to the rest position. An alternative but equivalent arrangement is illustrated in FIG. 8. There, the support 18 consists of two separate elements, as does the arm 20. The arm 20 in this arrangement is pivotally connected to the hood 48 (which is intended to be encompassed by the connections discussed above), such that the support 18, arm 20 and hood 48 together form a parallelogram linkage. The rest position is shown in solid line, and the work position shown in phantom.

The previous examples of angular adjustment of the arm 20 have been manual. As with the support 18, it is of course possible to instead used powered journals (not shown). These manual or powered journals, or their equivalents, are generally referenced as “means for angular adjustment of the cantilevered arm”.

While either or both of these adjustment means (length of support 18 and/or angle of arm 20) may be formed as powered elements, these powered elements may in turn be controlled manually or by control logic. For example, FIG. 1 shows a control unit 50 operatively connected to one or both of the adjustment means. The control unit 50 could consist of one or more simple switches (not shown) to cause powered adjustment upon manual activation of such switch.

Alternatively, the control unit 50 could include more sophisticated control logic. For example, it could include a timer to automatically reduce the length of arm 20 in a manner anticipated to maintain constant light intensity over the life of a standard (or particular) light bulb. Moving toward more sophistication, the control unit 50 could automatically adjust the length of support 18 in response to signals received from a light (or heat) sensor (not shown) to provide even more constant light (or heat) intensity within case 12. Other arrangements are of course possible.

With some high-end aquarium systems the aesthetics are a major concern. The present invention can assist in this area as well. In particular, it is possible to route unsightly wires in a manner concealing them.

As shown in FIG. 9, when a hood 48 is separately connected to arm 20, the operative items (lights 52, heating elements, etc.) connected to hood 48 have their power wires 54 threaded through an entrance hole 56 (FIG. 10) extending through (and aligned between) hood 48 and arm 20. The power wires 54 then leave the arm 20 through an exit hole 58 in arm 20. An accordion sleeve 60 may be fitted about the support 18 to hide the power wires 54. Similar alternative arrangements may also be employed to reduce or eliminate unseemly wires.

While discussing alternative arrangements, it is noted that the angular adjustment of arm 20 to permit access to the case 12 is preferred, but is not required. For example, in FIG. 11 the support 18 is connected to the means 16 via a journal permitting rotation about a lateral axis. The work position (shown in phantom) moves the arm 20 from blocking the case 20 very well in theory, but in practice there is often a wall or other obstruction preventing use of this arrangement.

Similarly, the embodiment of FIG. 12 shows the support 18 connected to means 16 via a journal permitting rotation about a longitudinal axis. This results in a work position (again shown in phantom) less often obstructed—at least when moving forward toward the viewing direction. Unfortunately, this also exposes the arm 20 (and associated operative items) to splashed water during maintenance, as well as exposing the user and workers to high temperatures from a hot hood 48 during work.

While many variations are shown above, it is intended to be clear that the means for length adjustment of the upright support and the means for angular adjustment of the cantilevered arm are independent. The invention may include one, the other, or both.

From the foregoing it will be seen that this invention is one well adapted to attain all ends and objects hereinabove set forth, together with the other advantages which are obvious and which are inherent in the structure and operation.

It will be understood that certain feature and subcombinations are of utility and may be employed without reference to other features and subcombinations. This is contemplated by, and is within the scope of, the claims.

Since many possible embodiments may be made of the invention without departing from the scope hereof, it is to be understood that all matter herein set forth or shown in the accompanying drawings is to be interpreted as illustrative, and not in a limiting sense.

What is claimed is:

1. An articulated aquarium light, comprising:
means for securing said light to ground;
an upright support mounted to said means for securing;
a cantilevered arm mounted to said upright support, said cantilevered arm being adapted to mount one or more of a light or heater; and
means for angular adjustment of said cantilevered arm about a substantially vertical axis.

2. An articulated aquarium light as in claim 1, wherein said means for angular adjustment of said cantilevered arm comprises a journal at a mounting point between said cantilevered arm and said upright support.

3. An articulated aquarium light as in claim 2, operatively associated with a case, said case comprising a base wall and one or more side walls, and wherein said case is a large case.

4. An articulated aquarium light as in claim 1, wherein said means for angular adjustment of said cantilevered arm comprises a journal at a mounting point between said upright support and said means for securing.

5. An articulated aquarium light as in claim 4, further including means for length adjustment of said upright support.

6. An articulated aquarium light as in claim 5, wherein said means for length adjustment of the upright support comprises means for powered length adjustment of the upright support, and further comprising:
a control unit operatively associated with said means for powered length adjustment.

7. In combination, a case and an articulated aquarium light, wherein:
said case comprising:
a base wall; and
one or more side walls, with an upper rim of said side walls defining an opening;
said articulated aquarium light comprising:
means for securing said light to ground, said means for securing being wedged between said case and ground;
an upright support mounted to said means for securing;
a cantilevered arm mounted to said upright support, said cantilevered arm being adapted to mount one or more of a light or heater.

8. The combination of claim 7, wherein said means for securing comprises a frame having a peripheral size and shape corresponding to that of said case.

9. The combination of claim 8, further including means for angular adjustment of said cantilevered arm about a substantially vertical axis.

10. The combination of claim 9, wherein said cantilevered arm includes a hood having a peripheral size and shape corresponding to that of said opening of said case.

11. The combination of claim 10, further comprising:
means for length adjustment of said upright support.

12. The combination of claim 7, wherein said means for securing comprises a plate.

13. The combination of claim 12, further including means for angular adjustment of said cantilevered arm about a substantially vertical axis.

14. The combination of claim 13, wherein said cantilevered arm includes a hood having a peripheral size and shape corresponding to that of said opening of said case.

15. The combination of claim 14, further comprising:
means for length adjustment of said upright support.

16. In combination, a case and an articulated aquarium light, wherein:
said very large case comprising:
a base wall; and
one or more side walls, with an upper rim of said side walls defining an opening;
said articulated aquarium light comprising:
means for securing said light to ground;
an upright support mounted to said means for securing;
a cantilevered arm mounted to said upright support, said cantilevered arm being adapted to mount one or more of a light or heater, and extending over said opening in a rest position.

17. The combination of claim 16, further comprising:
means for angular adjustment of said cantilevered arm about a substantially vertical axis.

18. The combination of claim 16, further comprising:
means for angular adjustment of said cantilevered arm about a substantially horizontal axis at a position sufficiently spaced from said cantilevered arm so as to permit oscillation of said cantilevered arm to a work position wherein said opening is substantially unobstructed.
